(19) United States
(12) Patent Application Publication
(10) Pub. No.: US 2011/0071933 A1
(43) Pub. Date: Mar. 24, 2011

(54) System For Surveillance Of Financial Data

(75) Inventors: Mohamed E. Daly, Palisades Park, NJ (US); Jorge Madrazo, Nutley, NJ (US)

(73) Assignee: MORGAN STANLEY, New York, NY (US)

(21) Appl. No.: 12/565,848

(22) Filed: Sep. 24, 2009

(51) Int. Cl. G06Q 40/00

(52) U.S. Cl. 705/35

(57) ABSTRACT

A system and method is disclosed for surveillance of financial data, comprising initiating a financial data surveillance module executable on a processor of a financial data surveillance computer system. Source data is retrieved from one or more data sources of a remote data server on which the source data is stored, the source data including transactions for a specific date and identification of the entity and account that each transaction is associated with. A metrics summary packet is generated for a particular account and the specific date, the metrics summary packet including one or more transaction classifiables that satisfy a predefined set of metric definition rules. A subjects packet is generated for the particular account that identifies the entities associated with the particular account, and a subjects-metrics packet is generated for the particular account by combining subject classifiables and metric classifiables within the subjects packet and metric summary packet. An aggregation packet is generated for an entity associated with the particular account, the aggregation packet including subject and metric classifiables of the subjects-metrics packet that satisfy a predefined set of aggregation rules. An evaluation score is generated for the entity by passing classifiables of the aggregation packet through a rules engine including a predefined set of scenario rules to determine if the aggregation classifiables are indicative of suspicious financial activity. A work item is generated if the evaluation score is indicative of suspicious financial activity.

### BACKGROUND

1. Field of the Invention

This disclosure relates generally to data analysis systems, and, more particularly, to an efficient system for surveillance of financial data.

2. Background

Many business transactions around the world are executed using digital representations of cash and other financial products residing in computer systems maintained by financial services corporations. This flexibility has created opportunities for money laundering, which is the concealment of the true source of currency used in a business transaction. Money-laundering techniques are used to inject money acquired from criminal activity into the legal financial realm. Financial services corporations have a need to identify and track suspicious transactions occurring within their accounts.

Large financial services corporations maintain millions of accounts on behalf of their clients accompanied by millions of transactions per day. Every transaction is typically stored in a database, where it may be analyzed for suspicious behavior. Scanning these massive volumes of data for potentially suspicious behavior is tedious and implementing an efficient surveillance program is highly complicated. Many clients have multiple accounts or multiple joint accounts necessitating review of the same accounts numerous times. Some money laundering transactions have different patterns, and discerning a suspicious transaction from all the legitimate transactions requires a precise evaluation of the transaction data.

### BRIEF SUMMARY

In one aspect of this disclosure, a system and method is disclosed for surveillance of financial data. The system and method comprises initiating a financial data surveillance module executable on a processor of a financial data surveillance computer system. Source data is retrieved from one or more data sources of a remote data server on which the source data is stored, the source data including transactions for a specific date and identification of the entity and account that each transaction is associated with. A metrics summary packet is generated for a particular account and the specific date, the metrics summary packet including one or more transaction classifiables that satisfy a predefined set of metric definition rules. A subjects packet is generated for the particular account that identifies the entities associated with the particular account, and a subjects-metrics packet is generated for the particular account by combining subject classifiables and metric classifiables within the subjects packet and metric summary packet. An aggregation packet is generated for an entity associated with the particular account, the aggregation packet including subject and metric classifiables of the subjects-metrics packet that satisfy a predefined set of aggregation rules. An evaluation score is generated for the entity by passing classifiables of the aggregation packet through a rules engine including a predefined set of scenario rules to determine if the aggregation classifiables are indicative of suspicious financial activity. A work item is generated if the evaluation score is indicative of suspicious financial activity.

The foregoing has outlined the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 is a high level representation of a financial data surveillance computer linked to an illustrative data server over an illustrative network;

FIG. 2 is a block diagram illustrating a preferred batch framework;

FIG. 3 is a block diagram of an illustrative execution strategy;

FIG. 4 is an illustrative hierarchy of financial data;

FIG. 5 is a schematic of an illustrative surveillance packet;

FIG. 5A illustrates a working example of an illustrative surveillance packet;

FIG. 6 illustrates another pair of illustrative surveillance packets;

FIG. 6A illustrates a merged pair of illustrative surveillance packets;

FIG. 7 illustrates a pair of illustrative classifiables;

FIG. 8 is a block diagram of an illustrative metadata tree;

FIG. 9 is a block diagram of an illustrative hierarchy of rules and operation of a setter rule on a classifiable;

FIG. 10 is a block diagram illustrating a preferred sequence of steps for surveillance of financial data;

FIG. 11 is a block diagram illustrating a working example of the generation of a metrics packet;

FIG. 12 is a block diagram illustrating a working example of the generation of a metrics summary surveillance packet;

FIG. 13 is a block diagram illustrating a working example of the generation of a subjects surveillance packet;

FIG. 14 is a block diagram illustrating a working example of the generation of an aggregations surveillance packet;

FIG. 15 is a block diagram illustrating a working example of the generation of an evaluation packet;

FIG. 16 is a block diagram illustrating a working example of the generation of a work item surveillance packet;

FIG. 17 is a block diagram illustrating a preferred sequence of steps for generation of a metrics surveillance packet;

FIG. 18 is a block diagram illustrating a preferred sequence of steps for generation of a metrics summary surveillance packet;

FIG. 19 is a block diagram illustrating a preferred sequence of steps for generation of an aggregations surveillance packet;

FIG. 20 is a block diagram illustrating a preferred sequence of steps for generation of an evaluation surveillance packet; and

FIG. 21 is a block diagram illustrating a preferred sequence of steps for generation of a work item packet.

### DETAILED DESCRIPTION

This application discloses a computer-implemented system and method for surveillance of financial data. As will be appreciated by one skilled in the art, this application may be embodied as a system, method or computer program product. Accordingly, this application may take the form of an entirely hardware embodiment, an entirely software embodiment (including firmware, resident software, micro-code, etc.) or an embodiment combining software and hardware aspects that may all generally be referred to herein as a “system.”

Furthermore, this application may take the form of a computer program product embodied in any tangible medium of expression having computer usable program code embodied in the medium. Any combination of one or more computer usable or computer readable medium(s) may be utilized. The computer-usable or computer-readable medium may be, for example (but not limited to), an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory, a read-only memory, an erasable programmable read-only memory (e.g., EPROM or Flash memory), an optical fiber, a portable compact disc read-only memory, an optical storage device, a transmission media such as those supporting the Internet or an intranet, or a magnetic storage device. Any medium suitable for electronically capturing, compiling, interpreting, or otherwise processing in a suitable manner, if necessary, and storing into computer memory may be used. In the context of this disclosure, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in base band or as part of a carrier wave. The computer usable program code may be transmitted using any appropriate medium, including (but not limited to) wireless, wire line, optical fiber cable, RF, etc.

Computer program code for carrying out operations of the present application may be written in any combination of one or more programming languages, including an object oriented programming language such as Java, C++, C# or the like and conventional procedural programming languages, such as the “C” programming language or similar programming languages. The program code may execute entirely on a financial data surveillance computer, partly on a financial data surveillance computer, as a stand-alone software package, partly on a financial data surveillance computer and partly on a remote financial data surveillance computer, or entirely on a remote financial data surveillance computer or server. In the latter scenario, the remote financial data surveillance computer may be connected to a local financial data surveillance computer through any type of network, including a local area network (LAN) or a wide area network (WAN), or the connection may be made to an external computer (for example, through the Internet using an Internet Service Provider).

This application is described below with reference to flowchart illustrations and/or block diagrams of methods, apparatus (systems) and computer program products according to one or more embodiments. It will be understood that each block of the flowchart illustrations and/or block diagrams, and combinations of blocks in the flowchart illustrations and/or block diagrams, can be implemented by computer program instructions. These computer program instructions may be provided to a processor of a financial data surveillance computer such that the instructions, which execute via the processor of the computer, create means for implementing the functions/acts specified in the flowchart and/or block diagram block or blocks.

These computer program instructions may also be stored in a computer-readable medium that can direct a financial data surveillance computer to function in a particular manner, such that the instructions stored in the computer-readable medium implement the function/act specified in the flowchart and/or block diagram block or blocks. The computer program instructions may also be loaded onto a financial data surveillance computer to cause a series of operational steps to be performed on the financial data surveillance computer to produce a computer implemented process such that the instructions that execute on the financial data surveillance computer provide processes for implementing the functions/acts specified in the flowchart and/or block diagram block or blocks.

This application makes reference to several complex data structures (e.g., packets, data trees, metadata trees, etc.). As would be understood by one of ordinary skill in the art, these complex data structures may be implemented using different types of programming data structures such as (a non exhaustive list): linked lists, doubly linked lists, arrays, arrays of objects, multi dimensional arrays, 2-4 trees, etc. It is intended that the data structures disclosed in this application be construed as including all possible programming data structure implementations, modifications and variations insofar as they come within the spirit and scope of the data structures disclosed herein.

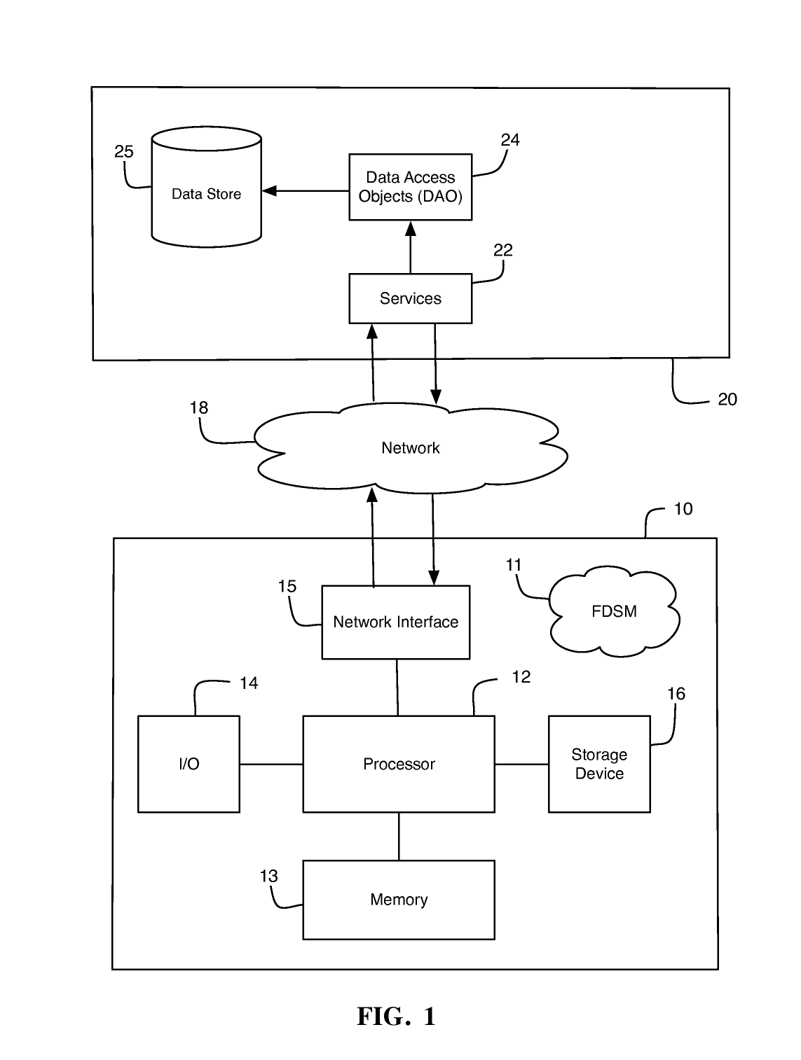

Referring to FIG. 1, a financial data surveillance computer system 10 is shown that is configured for implementation of financial data surveillance module 11 (“FDSM”). Financial data surveillance computer system 10 preferably includes a processing unit 12, memory 13, input/output (“I/O”) interface 14, network interface 15, and storage device 16, all of which operate collectively to execute the instructions encoded in FDSM 11. FDSM 11 functions by preferably loading into memory 13 and having its instructions executed by processor 12. Processor 12 is preferably a collection of interconnected semiconductor transistors that transform into “on” and “off” states as the instructions of FDSM 11 are executed. FDSM 11 may be part of the operating system for best efficiency. Alternatively, the operating system may invoke one or more separate software applications to employ FDSM 11. One of ordinary skill in the art will recognize that an implementation of a financial data surveillance computer may contain additional components and that FIG. 1 is a high level representation of some of the components and processes of such a computer for illustrative purposes. For example, services and data access objects implemented as part of the solution may optionally reside on the same machine as FDSM 11.

FIG. 1 also shows an illustrative network 18 and an illustrative remote data server 20. Illustrative remote data server 20 may contain services 22 linked to data access object 24 that interfaces with a data store 25. Data store 25 may be a conventional database, flat file, or the like. One of ordinary skill in the art will recognize that different network configurations are also possible and that the network illustrated in FIG. 1 is for illustrative purposes. It is also understood that the data store 25 may reside locally on financial data surveillance computer system 10. It is further understood that data store 25 is not limited to a single data store. Simultaneous use of a variety of data stores may be desirable depending on the needs of the end user.

FDSM 11 preferably processes source data in batch mode. Source data may be, for example, the individual financial transactions (e.g., wires, trades, transfers, etc.) and the entity(s) to which these transactions are associated. The entity may be, for example, the account where the transaction originated or a group of related accounts that can be linked by certain criteria.

FDSM 11 preferably adheres to a framework that permits building entire batch jobs from individual batch task implementations that facilitates alteration of the task execution sequence via configuration files. Tasks that are run sequentially may easily be altered to run in parallel using one configuration entry. The framework allows a user or administrator to define an execution strategy. An execution strategy provides the FDSM 11 with instructions that direct FDSM 11 based on the current state of each executing task. An execution strategy combines a run mode with a set of execution phases; each execution phase encapsulates a number of execution patterns, and each execution pattern associates a current state with the next step to take upon success or failure of a batch task.

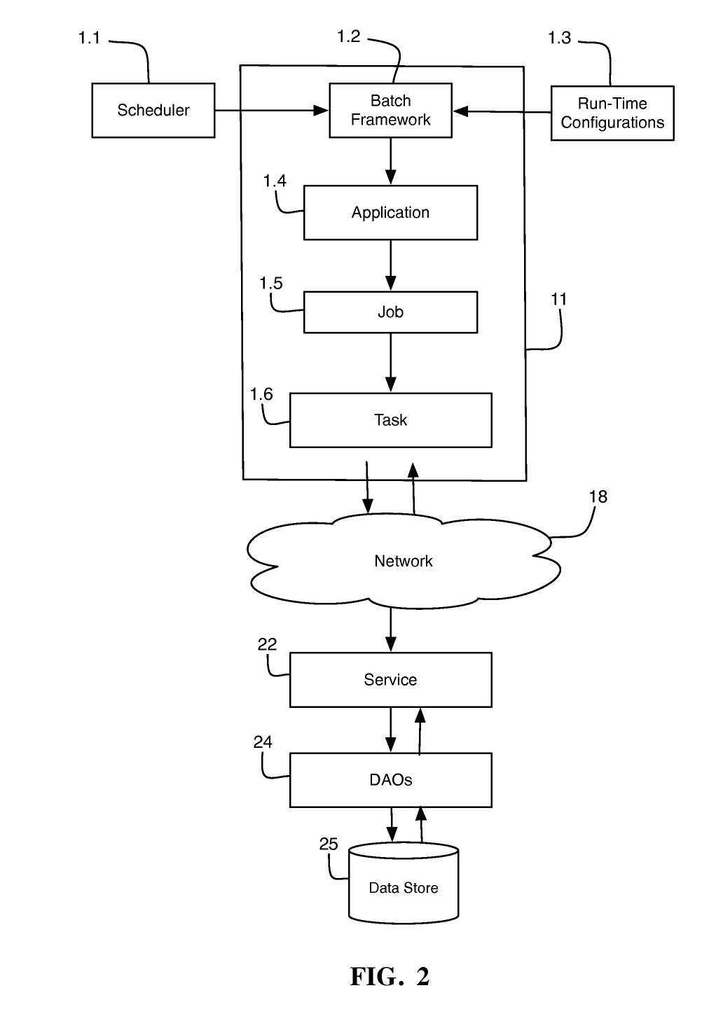

FIG. 2 is a schematic of a preferred batch framework of FDSM 11 executing task 1.6. Scheduler 1.1 invokes the batch framework module of FDSM 11. Scheduler 1.1 may be any conventional job management tool (e.g., autosys, etc.). Configuration file 1.3 may contain the task execution sequence and whether the task should be run sequentially or in parallel. The configuration file 1.3 may also contain the execution strategy and execution patterns defined by the user or administrator. Batch framework module 1.2 may open and parse configuration file 1.3 to read the execution sequence, strategy, and parameters defined by the user or administrator. Once the batch framework module 1.2 has deciphered the execution parameters of the configuration file, the batch module 1.2 preferably instructs the application module 1.4 of FDSM 11 to initiate a job 1.5. The job 1.5 may then initiate at least one task 1.6 pursuant to the execution strategy defined in the configuration file 1.3. Each individual task container 1.6 may be automatic, re-startable, and re-runable. Furthermore, each individual task container 1.6 may be plugged with services 22 via network 18 that may, in turn, be plugged with data access objects 24 to form an entire application hierarchy. Data store 25 may be any conventional database (e.g., Sybase, Oracle, spreadsheet, flat file, etc.). Nesting of tasks may be set to any level and, if one task, such as, for example, task 1.6 in a large application hierarchy fails, task 1.6 will preferably continue from the point of failure by identifying the execution patterns described in the configuration file 1.3. An execution key will preferably accompany any data generated by each task container 1.6. The execution key helps identify the task that generated the data and allows a user or an administrator to roll back an entire task that failed in mid execution. The execution key also allows a user or administrator to cleanse any bad data.

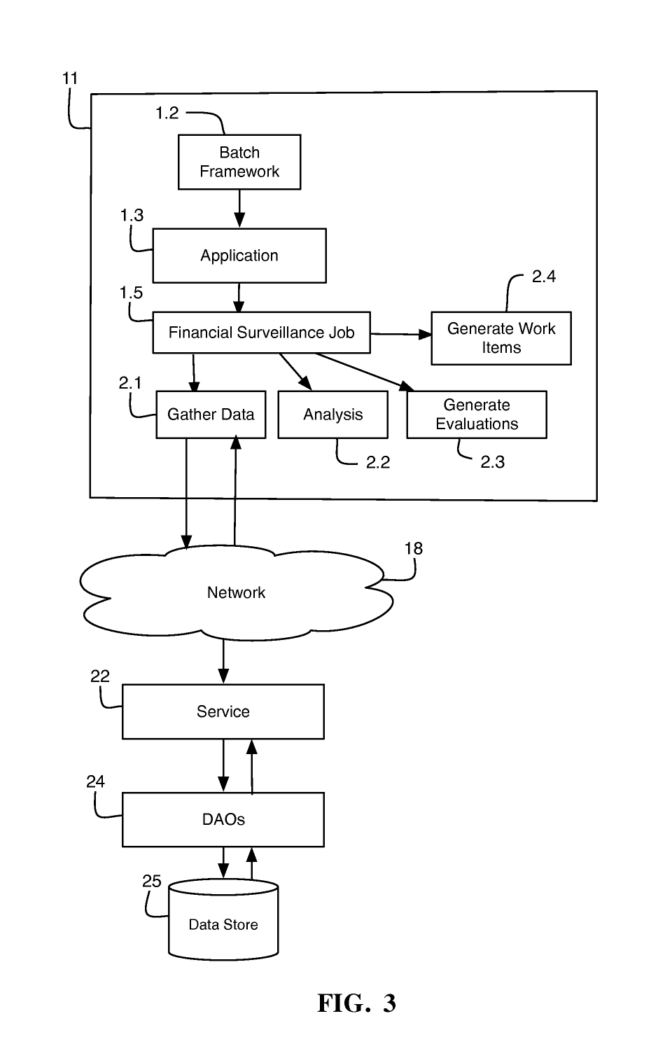

FIG. 3 illustrates a working example of the batch framework. In FIG. 3, job 1.5, illustratively labeled “financial surveillance job,” is shown implementing tasks 2.1 thru 2.4. FDSM 11 may also define task containers that group a number of tasks, such as tasks 2.1 to 2.4, that may be run sequentially or in parallel. Each task may be responsible for different phases of the financial data surveillance execution. As stated above, each task will assign an execution key to any data it generates. In the example of FIG. 3, task 2.1 is responsible for gathering data, task 2.2 is responsible for analyzing the data, task 2.3 is responsible for generating evaluations, and task 2.4 is responsible for generating work items. It is understood that the execution strategy shown in FIG. 3 is illustrative and that a user or administrator may define many different types of execution strategies.

All the data (e.g., surveillance packets) are preferably generated by each task 2.1-2.4. The data generated is preferably owned by the job instance 1.5 that initiated the respective tasks. All data is preferably associated with a segment identifier. Each segment is an environment totally isolated from all other instances of FDSM 11 on the same infrastructure. Using the segment identifier, all relevant data may be linked to a particular job. Because the source data is read only, source data can be shared with other application instances.

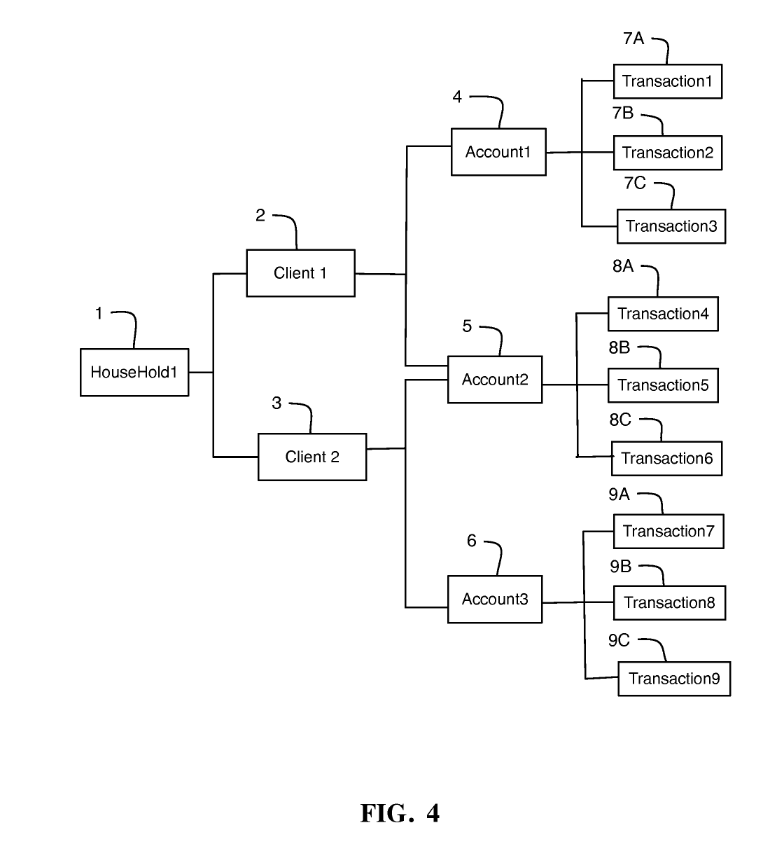

FDSM 11 preferably reads in source data that may, for example, contain account and transaction information occurring on different dates. FDSM 11 generates data throughout its execution and at termination, which may be referred to herein as “surveillance data.” While the source data is preferably organized as a hierarchy of source data elements as illustrated in FIG. 4, it is understood that the source data may have a different hierarchy and still facilitate efficient surveillance of the source data. The hierarchy of FIG. 4 may be implemented in data store 25, which may be a conventional database (e.g., Sybase, Oracle, flat file, etc.), and then loaded or stored in memory 13 via a task (e.g., task 2.1).

FIG. 4 shows a root data item 1 labeled “Household1” linked to data item 2 and data item 3 labeled “client1” and “client2,” respectively, that in turn is linked to data items 4-6 that are labeled “account 1,” “account 2” and “account3,” respectively. Each of these accounts are then linked to several transaction data items 7A-7C, 8A-8C, 9A-9C. Each source data element in the hierarchy is preferably associated with at least one attribute. The data elements and their respective attributes are preferably stored in a Java object that implements a marker interface. This java marker interface may be referred to herein as a “surveillance item.” The attributes will preferably be applied to rules attached to nodes of a metadata tree as will be discussed in more detail further below. As will be understood by one of ordinary skill in the art, the data may be stored in data structures of other object-oriented languages such as C++ or C#. If Java is used, each object that stores and manages the source data elements preferably implements the surveillance item interface. It is understood that the phrase “surveillance item” is illustrative and that any other suitable terminology may be used.

A surveillance packet is a data structure that preferably stores a group of related surveillance items. This data structure may be identified by an object referred to as a “Packet Key,” but may also have any other suitable name. The packet key is the entity or object that links all surveillance items in the packet together. A surveillance packet preferably groups related surveillance items together into one linked data structure. A surveillance packet allows multiple sets of packets to be compared, sorted, and merged together to create larger data structures.

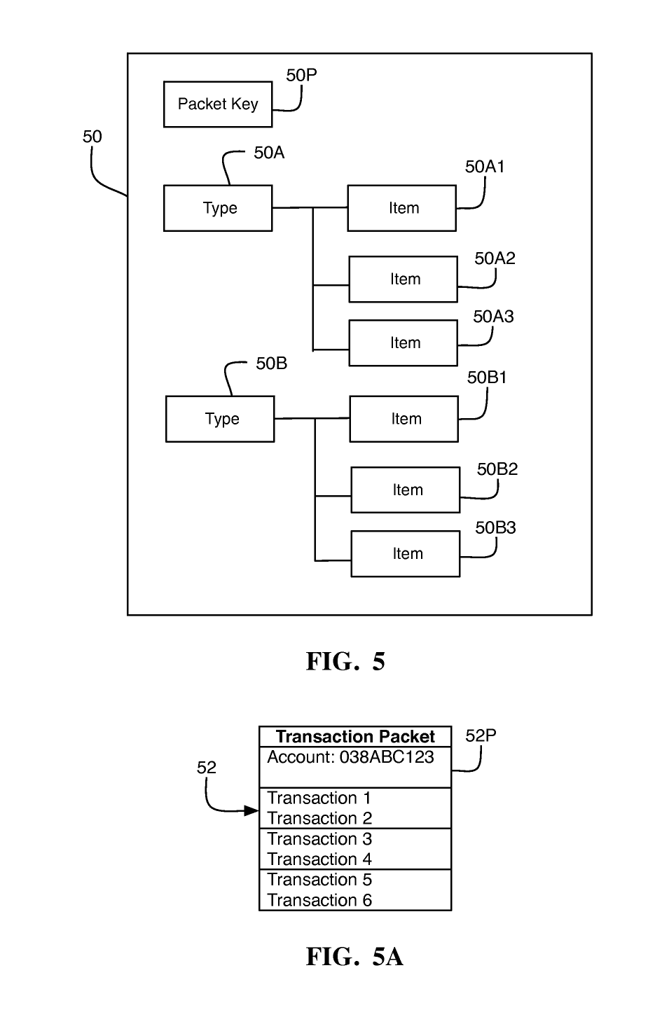

FIG. 5 shows an illustrative surveillance packet 50 having, for example, surveillance items 50A1-50A3 of surveillance item type 50A. Surveillance packet 50 is also shown to have surveillance items 50B1-50B3 of surveillance item type 50B. Surveillance packet 50 preferably includes a packet key 50P, which preferably acts as a unique identifier for each surveillance packet.

FIG. 5A shows another illustrative surveillance packet 52 of type transaction. The packet key 52P of surveillance packet 52 is “Account,” which, in this example, is “000ABC123.” The surveillance items for “Account” are the transactions labeled “Transaction 1” through “Transaction 6.”

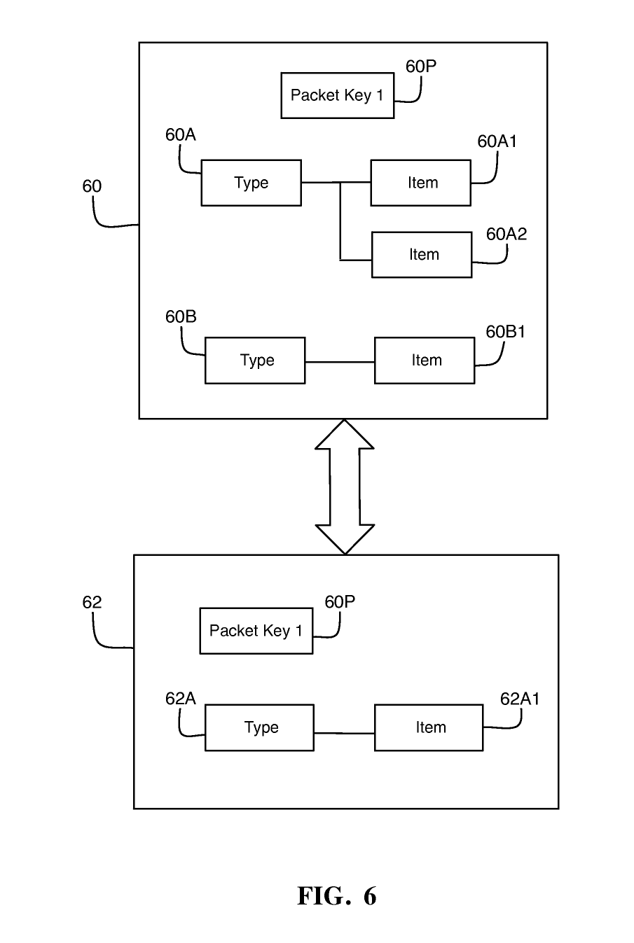

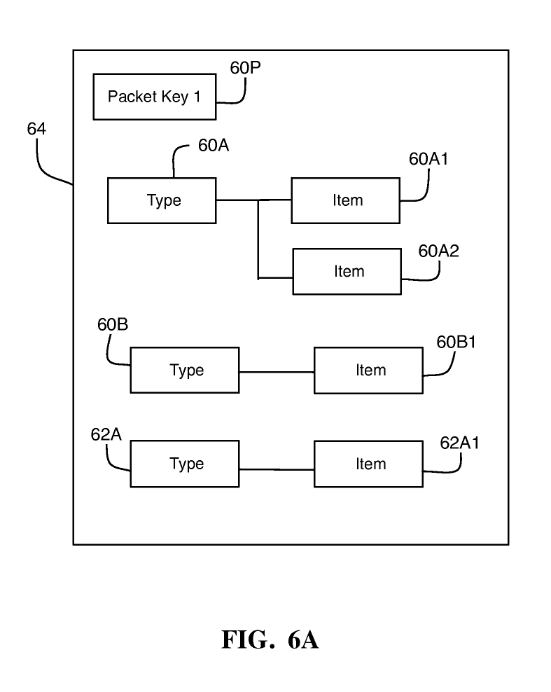

FIG. 6 illustrates how two sets of packets retrieved from disparate data sources can be merged if they have matching packet keys. FIG. 6 shows illustrative surveillance packet 60 having a packet key 60P. By way of example, assume surveillance packet 60 also contains surveillance item type 60A linked to surveillance items 60A1 and 60A2. Furthermore, assume surveillance packet 60 contains surveillance item type 60B linked to surveillance item 60B1. FIG. 6 also shows illustrative surveillance packet 62 having packet key 62P. Surveillance packet 62 has, by way of example, surveillance item type 62A linked to surveillance item 62A1.

FDSM 11 will preferably allow surveillance packet 60 and surveillance packet 62 to merge and create a new surveillance packet 64, as shown in FIG. 6A, because they have the same packet key 60P. Referring to FIG. 6A, surveillance packet 64 is a merged packet containing the contents of surveillance packet 60 and surveillance packet 62. The merged packets will preferably contain a superset of all the items in the original packets. It is understood that surveillance packet 60 and 62 are illustrative and that other type, item and key combinations are possible. For example, packets of the same type may also be merged.

The surveillance packets preferably dispatch their contents for rules processing. The contents of the packets are preferably dispatched into what may be referred to as a classifiable, a classifiable packet, or simply a packet. Surveillance packets that contain multiple surveillance item types preferably dispatch a classifiable for each combination of item types in the packet, but may also be configured to dispatch their contents in a number of different ways. These classifiables are preferably containers of other objects (e.g., transactions) that are able to dynamically expose the attributes of their contained objects to the rules for inspection.

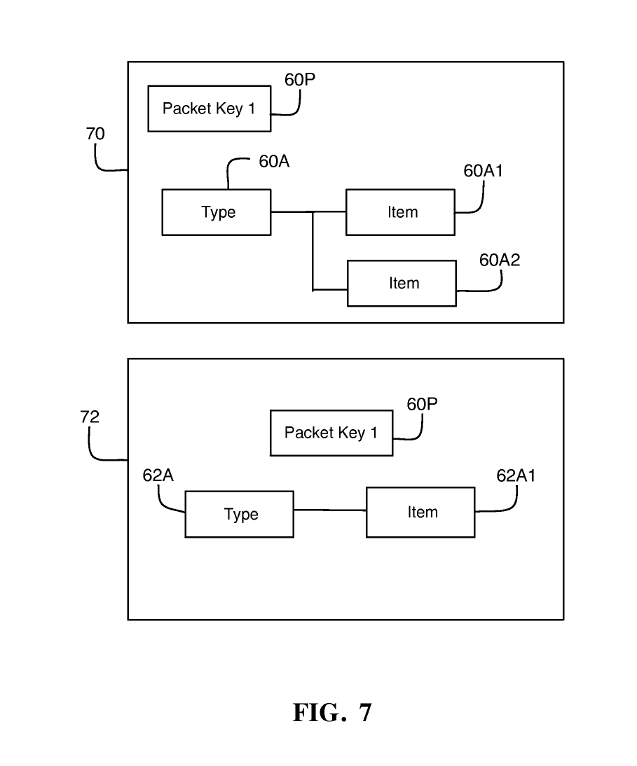

FIG. 7 shows two illustrative classifiables dispatched from the illustrative merged packet 64 of FIG. 6A. Classifiable packet 70 is shown having a packet key 60P and surveillance item type 60A linked to surveillance item 60A1 and 60A2. Classifiable 72 is shown having packet key 60P and surveillance item type 62A linked to surveillance item 62A1. Classifiable packets, such as the classifiable packets illustrated in FIG. 7, will preferably be passed through the metadata tree for rules processing. Each dispatched classifiable is processed by the rules attached to the nodes of a metadata tree that will preferably inspect the attributes of the surveillance items in the classifiable by preferably using introspection. The classifiable 72 shown in FIG. 7 may have, for example, an attribute called “net-Amount” in surveillance item 62A1. During rules processing, this attribute value may be captured using a dynamic get-Property call on a string representation of the attribute that may be encoded as the following: Cl2.getProperty(“data[type2].net-Amount”). Alternatively, a get-Property call may be intercepted and converted into a direct method call on the contents of the classifiable. This alternative is more efficient for more commonly used properties, but, if a property is not known, the default will preferably be to capture the value via introspection.

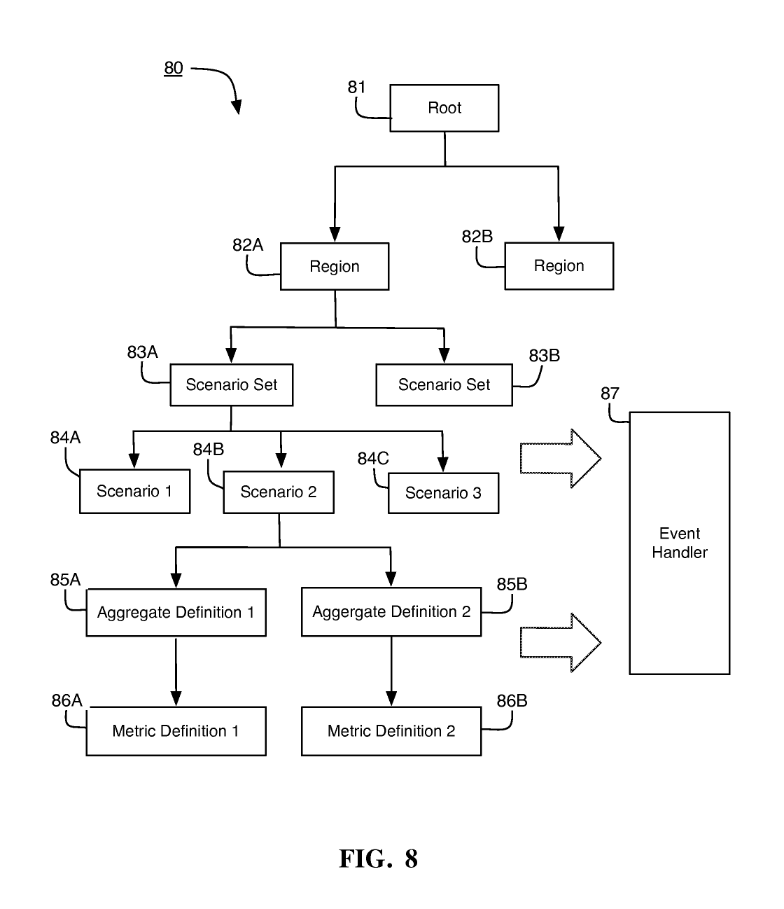

FIG. 8 depicts an illustrative arrangement of a metadata tree 80 that facilitates the implementation of a rules engine. Most of the nodes in the metadata tree 80 are preferably attached to rules that are preferably applied to attributes of the classifiable packet passing through them. Each node may be called a “classifier.” The rules are another hierarchical dimension that extend from each classifier and may also have child rules. The classifiers preferably use their attached hierarchy of business rules to evaluate the classifiable and, if the rule is satisfied, the classifier preferably notifies the event handler 87 to record the event and forward the classifiable to any child classifiers attached to it. An event handler is a collection of executable computer instructions designed to be executed when an associated event occurs. The event handler 87 may create new surveillance packets that may also be passed through the metadata tree 80. In one embodiment, FDSM 11 will involve multiple cycles of packets through the metadata tree 80 until the process is complete and the work items are generated. Dispatching the classifiable packets into the metadata tree 80 may be done in broadcast mode to take advantage of parallel processing across the nodes.

The illustrative metadata tree 80 shown in FIG. 8 illustrates different types of nodes or classifiers that may be implemented on the tree. The region classifiers 82A, 82B may be responsible for forwarding the classifiable packet to the nodes containing rules specific to a geographical region or business unit. The scenario set classifiers 83A, 83B may determine whether the packets are of a particular data element (e.g., account, client, transaction, etc.) in order to direct the classifiable to the appropriate child nodes. The scenario classifiers 84A, 84B, 84C may determine whether the classifiable contains data combinations that satisfy scenarios indicative of money laundering activity (e.g., wiring money to a country deemed hostile or rogue, wiring money to organizations deemed terrorist organizations, etc.). The aggregation definition classifiers 85A, 85B may be used to filter out transactions that are outside a specified date range or out of scope. Finally, the metric definition classifiers 86A, 86B may confirm whether a certain number of cash movements were sent into an account from a specific outside source or outside the account to an outside source. The nodes of the metadata tree 80 preferably notify event handler 87 if the attributes of the classifiable packet passing through them satisfy their attached rules. Event handler 87 may create additional packets as will be described in more detail below. It is understood that the metadata tree 80 may have different arrangements with other types of classifiers or nodes and that the nodes illustrated in FIG. 8 are not intended to be an exhaustive list of node types.

Each and every node and relationship between two nodes in the metadata tree 80 is preferably stored as a database record. Changes to the definition of the metadata tree 80 may be fully audited using the business date and the calendar date. Auditing the data using business date and calendar date ensures that any state of the metadata at any point in time can be re-created and used to replay prior processing. Every node or classifier in the metadata tree 80 may be reused, but, if a classifier appears twice in a metadata tree 80, the classifiable will preferably cache the results of the evaluation for each node that it passes through for efficiency. Doing so preferably prevents duplicative evaluation of a classifiable by a node definition repeated multiple times in the tree structure.

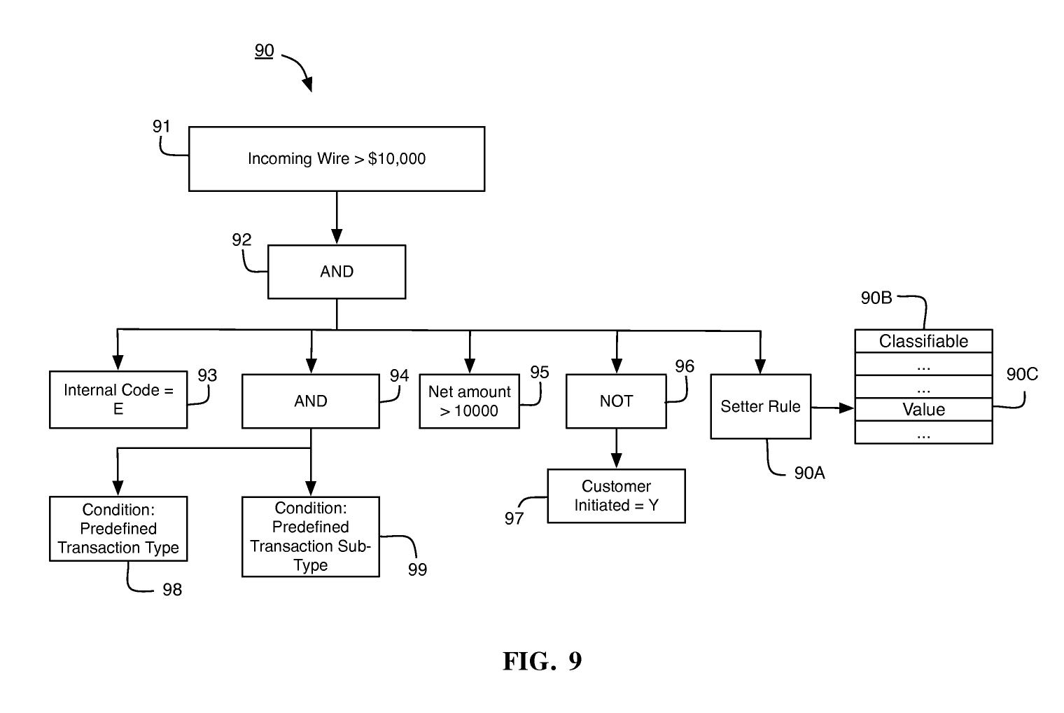

FIG. 9 shows an illustrative rule hierarchy 90 that may be attached to a classifier in the metadata tree 80 of FIG. 8. The rules attached to the classifier may be implemented as conditional rules, setter rules, or looping rules. A setter rule may set a value 90C in a classifiable as it passes through the rule. The value may take any form or format appropriate to the implementation. This new value 90C may be logically joined with or inspected by any other rule in the hierarchy.

The root node 91 is a classifier that determines, by way of example, whether a transaction is an incoming wire to the account and has a value that is greater than a predefined threshold (e.g., $10,000). If so, then setter rule 90A may set “true” or “1” in field 90C (which is a Boolean value in this example) of classifiable 90B. Subsequently, the exemplary value generated by node 91 may be inspected by other rules in the metadata tree 80 of FIG. 8. The classifiable representing the transaction is first received by the classifier node 91. Classifier node 91 will forward the classifiable to its root rule 92. Root rule 92, as a conditional AND rule, will pass the classifiable to its first child rule 93. If rule 93 is satisfied, root rule 92 will pass the classifiable to the next child rule 94. Rule 94 may be, for example, another AND rule that will pass the classifiable to its children rules 98 and 99, and will be satisfied if and only if all of its children rules are satisfied. If rule 94 is satisfied, root rule 92 will pass the classifiable to the next child rule 95. If rule 95 is satisfied, root rule 92 will pass the classifiable to the next child rule 96. Rule 96, as a NOT rule, will be satisfied if its only child rule 97 is not satisfied. If all of the children rules 93, 94, 95 and 96 are satisfied, root rule 92 will now pass the classifiable to its last child, setter rule 90A. Setter rules do not affect the outcome of their parent rules, but only set values on the classifiable. These values will later be inspected by other rules in the metadata tree 80 of FIG. 8. In FIG. 9, setter rule 90A assigns, for example, a Boolean value of “true” to field 90C of classifiable 90B if all of the previous sibling rules 93, 94, 95 and 96 were satisfied. This assignment may, for example, help other rules in other branches of metadata tree 80 of FIG. 8 find transactions that were correctly identified as incoming wires of a value greater than $10,000 by classifier 91. If any of the rules 93, 94, 95 or 96 is not satisfied, the classifiable will not make it to setter rule 90A and, hence, the field 90C will retain its original value, for example, “0” or “false.” After passing through the setter rules tree 90, the final result in field 90C will either be “1” or “true,” or “0” or “false.” Either value may be configured to trigger the event handler 87 of FIG. 8. It is understood that other implementations are possible, and the above is merely one exemplary way of enabling the setter rule.

Looping rules are rules that may process a classifiable that contains a collection of objects as a list. The rule may repeat its evaluation of the classifiable for each item on the list until the list is exhausted.

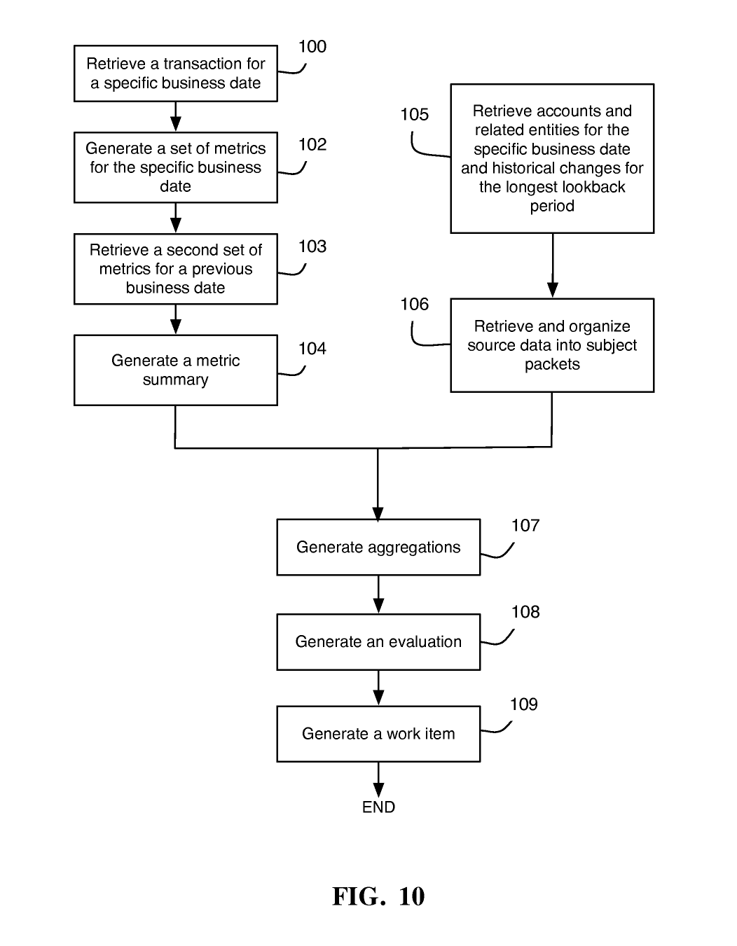

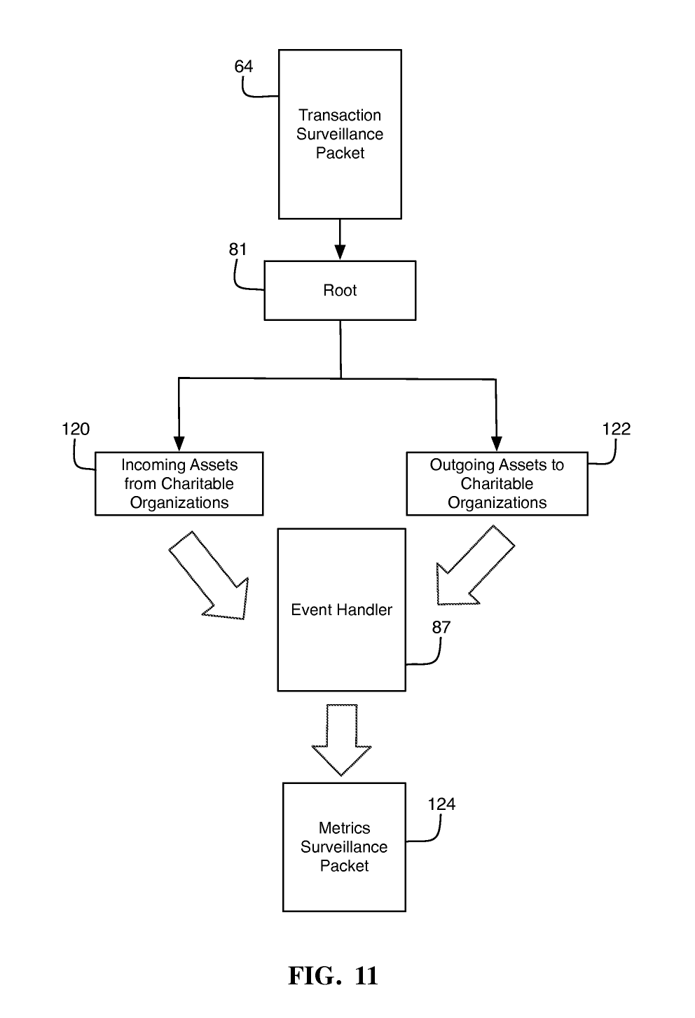

FIG. 10 is a high level illustration of a preferred sequence of steps for generating a work item or alert that warns of suspicious transactions occurring in a banking account. In step 100, transactions are preferably retrieved for a particular business day, which will preferably be stored as a surveillance transaction packet. In step 102, metrics are preferably generated for the current day. These metrics are preferably derived by passing the surveillance transaction classifiable through a metric definition classifier. FIG. 11 illustrates how a classifiable from, for example, a transaction surveillance packet 64 is passed through a pair of illustrative metric definition classifiers 120, 122 from root node 81. By way of example, assume the illustrative metric definition classifier 120 determines whether incoming asset movements came from charitable organizations and metric definition classifier 122 determines whether outgoing asset movements were destined to a charitable organization. Any transaction classifiable that satisfy these metric definition rules will preferably trigger the event handler 87 that inserts the classifiable into a newly generated metrics packet 124. These steps are preferably repeated until all transaction classifiables are processed into metric packets.

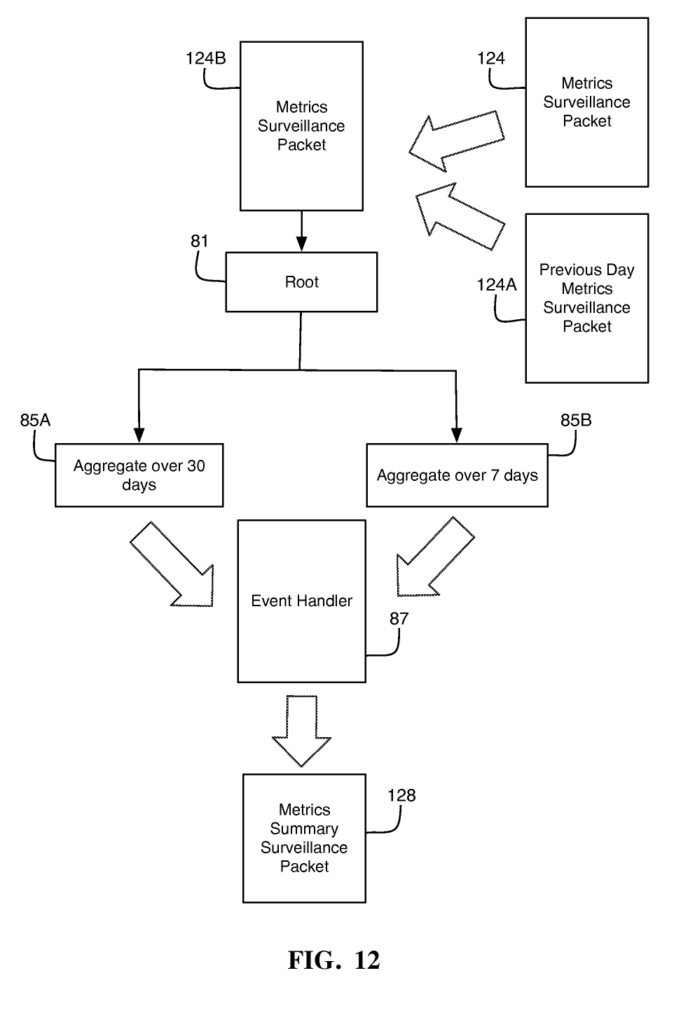

Referring back to FIG. 10, after all transaction classifiables are processed into metric packets, FDSM 11 preferably retrieves, for example, the previous day's metric summary in step 103. In step 104, FDSM 11 preferably generates a metric summary. FIG. 12 illustrates how the metric summary may be generated. The previous day's metric summary 124A is merged with the current day's metrics 124 to form a new metric packet 124B. A classifiable from packet 124B is preferably passed through the root node 81 and forwarded to aggregate node 85A and aggregate node 85B. By way of example, assume aggregate node 85A will keep any transactions that are less than thirty days old, while node 85B keeps any transaction that is less than seven days old. The aggregate node that is applied depends on how the packet is routed from the previous nodes (e.g., the scenario nodes). The classifiables satisfying these conditions will be stored in a new metrics summary surveillance packet 128 generated by the event handler 87. These steps are preferably repeated until all metrics have been processed into metrics summary surveillance packets.

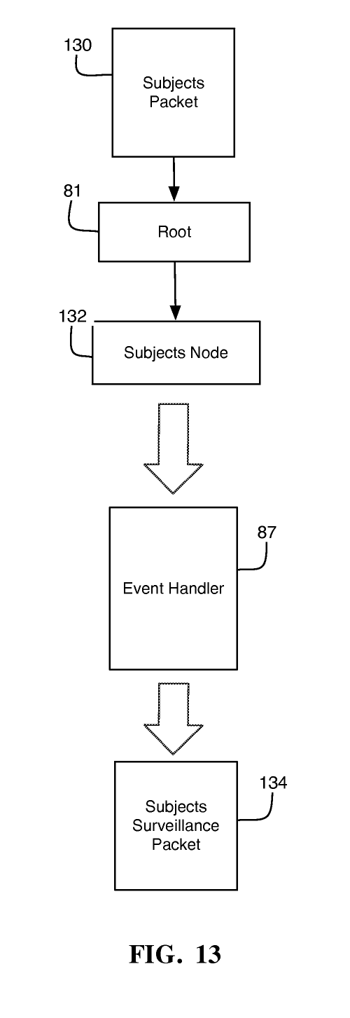

Referring back to FIG. 10, FDSM 11, in a separate process, preferably organizes the source data into subjects in step 106 by preferably generating subject surveillance packets. These packets may be created by preferably reading in the source data and creating packets for each data element (e.g., accounts, clients, transactions, etc.) shown in the hierarchy illustrated in FIG. 4. FIG. 13 illustrates how subject packet 130 is preferably passed through root node 81 and a special node in the metadata tree 80 called a subjects node 132. Subjects node 132 preferably calls event handler 87 to generate a subjects surveillance packet 134. These steps are repeated until all transactions have been processed into subjects surveillance packets. In one embodiment, subjects surveillance packet 134 may be generated without applying any rules. Alternatively, rules may be applied to subject packets when needed by the end user. For example, surveillance on a subset of accounts may be conducted by filtering the entire population of accounts through the rules engine.

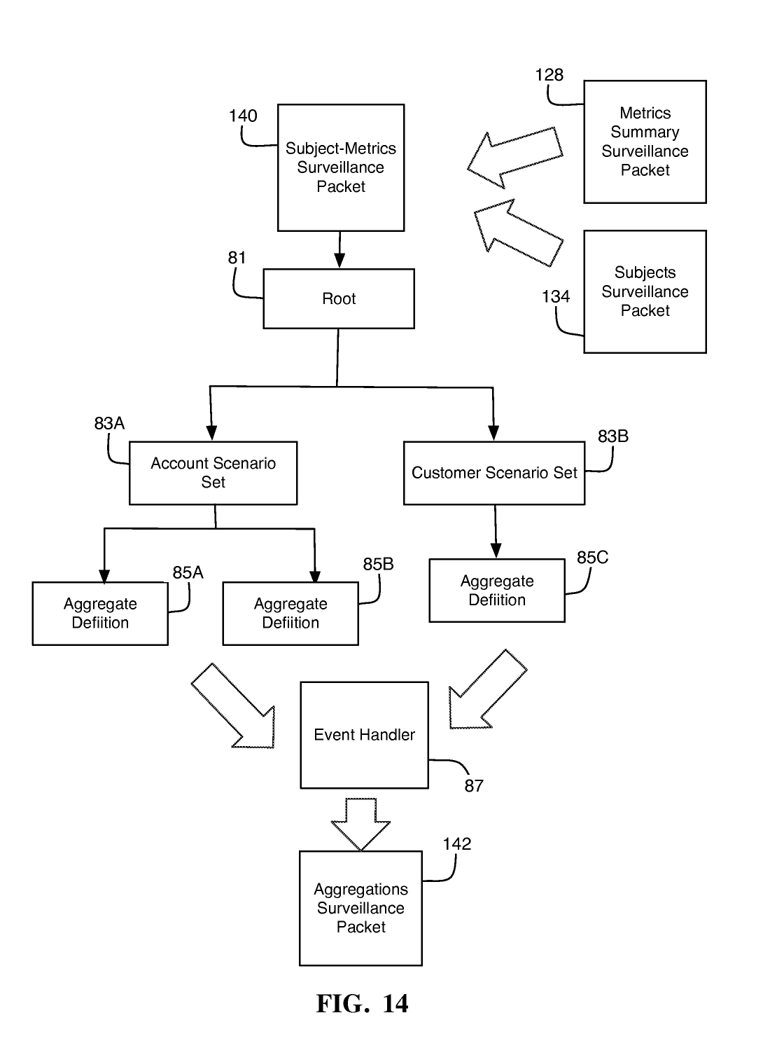

In step 107 of FIG. 10, FDSM 11 preferably generates aggregations. FIG. 14 illustrates how the aggregations may be created by preferably joining subject packets 134 and metrics packet 128 to form a new merged subjects-metrics packet 140. FDSM 11 preferably passes classifiables from packet 140 through root node 81 that, in turn, may be forwarded to aggregate nodes 85A, 85B or forwarded to aggregate node 85C. The aggregate nodes that the classifiables from packet 140 are forwarded to may depend on, for example, whether the classifiable from surveillance item pack 140 satisfies the rules attached to account scenario node 83A or customer scenario node 83B. In this example, account scenario 83A routes classifiables from merged packet 140 to its child nodes, aggregate node 85A, 85B, if the subject of the classifiable is an account data type. Customer scenario node 83B routes the classifiables from merged packet 140 to its child node 85C if the subject of the classifiables from merged packet 140 is of customer data type. It is understood that the rules attached to the scenario nodes of FIG. 14 are illustrative, and that the nodes may implement any rule desired. If any of the aggregate node rules are satisfied, event handler 87 will preferably create an aggregations packet 142. These steps are preferably repeated until all metrics and subjects have been processed into aggregation surveillance packets.

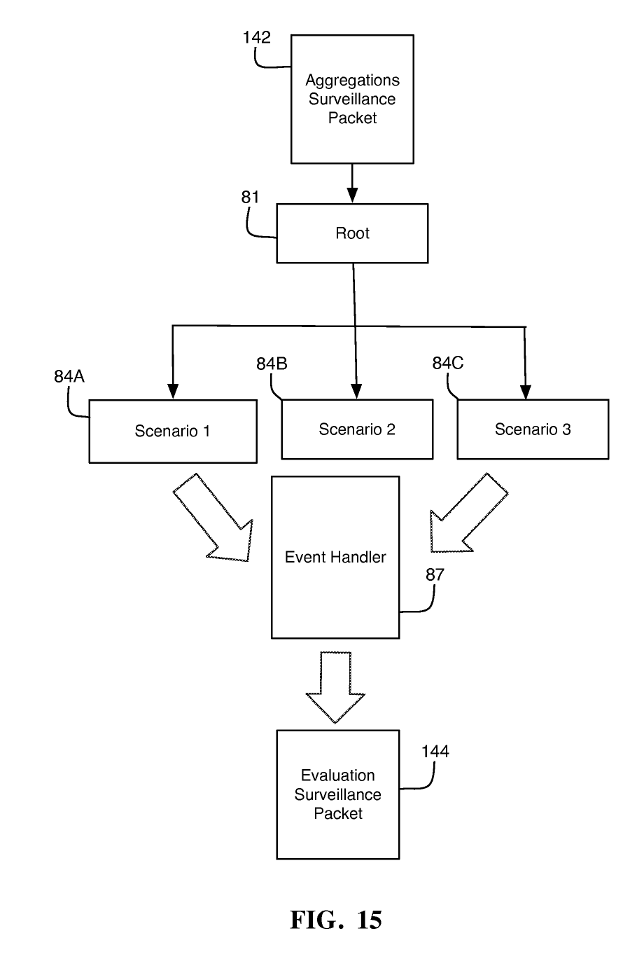

Referring back to FIG. 10, after all transactions have finished generating aggregations (step 107), FDSM 11 preferably generates an evaluation in step 108. The evaluation may be generated by preferably passing the classifiables of aggregation packet 142 through scenario classifiers. FIG. 15 illustrates an example of how the evaluation packets may be generated. In FIG. 15, classifiables of aggregation packet 142 are preferably passed through root node 81 and then preferably applied to scenario nodes 84A, 84B and 84C. Each scenario node will preferably have rules attached, such as, for example, the illustrative rules shown in FIG. 9, which may be indicative of money laundering behavior. The event handler 87 is preferably invoked by FDSM 11 and an evaluation packet 144 is preferably generated. These steps are preferably repeated until all aggregations have been processed into evaluation surveillance packets.

FDSM 11 preferably determines whether the evaluation score encapsulated in the evaluation packet 144 indicates suspicious behavior and generates a work item if it does in step 109. The work item will preferably be presented to the end users for investigation. If the evaluation score does not indicate suspicious behavior in step 108, then, preferably, a work item is not generated.

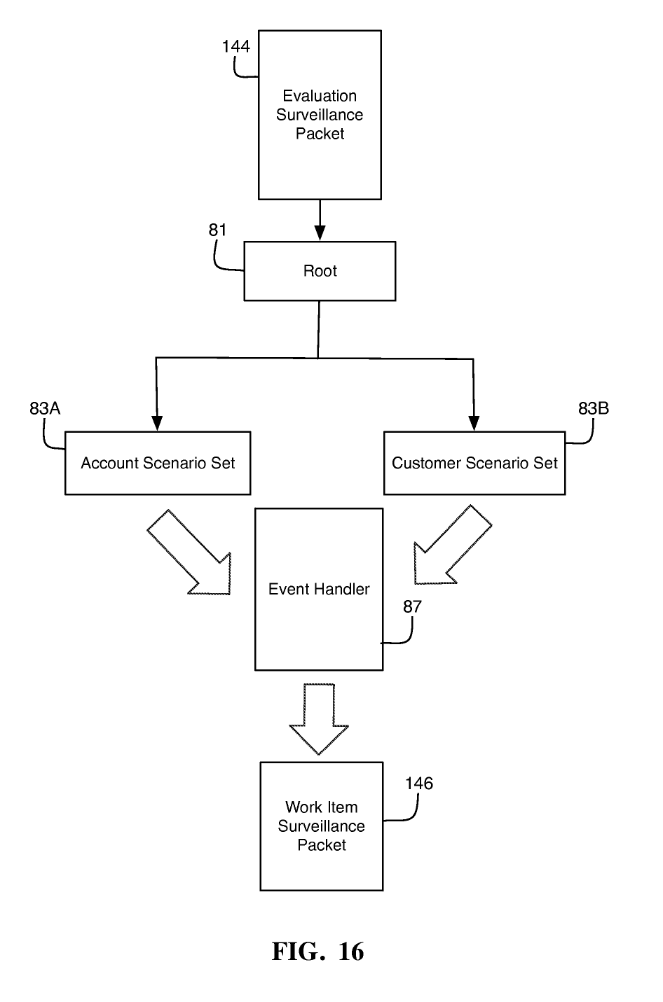

FIG. 16 illustrates an example of how the work item is generated. FDSM 11 passes a classifiable from evaluation packet 144 through root node 81. In this example, the work item 146 is generated by account scenario set node 83A or customer scenario set node 83B. However, it is understood that another node may be configured to generate the work item 146. Scenario set 83A or scenario set 83B may determine whether the score encapsulated in the evaluation packet 144 is indicative of money laundering, and, if so, scenario set 83A or scenario set 83B will call upon event handler 87 to create work item surveillance packet 146. The information contained in the work item 146 is preferably used to display the relevant information to the end user for investigation.

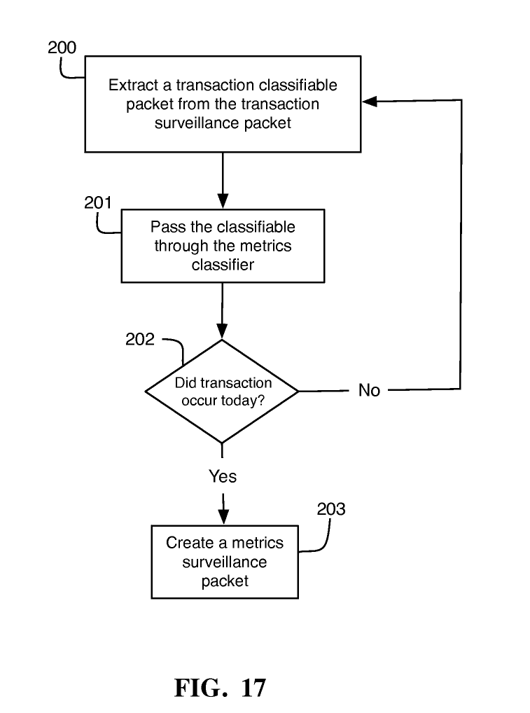

FIG. 17 illustrates a preferred sequence of steps for generating the metrics of step 102 of FIG. 10. In step 200, FDSM 11 preferably extracts a transaction classifiable from the transaction surveillance packet. In step 201, FDSM 11 preferably passes the classifiable through a metrics classifier. In step 202, FDSM 11 preferably determines whether the transaction represented by the transaction classifiable occurred on the current date and whether is satisfies the rule of the metric classifier. If so, FDSM 11 preferably invokes the event handler 87 to create a metrics surveillance packet in step 203. Otherwise, FDSM 11 will preferably read the next transaction surveillance classifiable by looping back to step 200. It is understood that the classifiable packet may be required to satisfy rules attached to higher-level classifier nodes before being forwarded to the metrics classifier. This loop will preferably continue until the classifiables in the transaction surveillance packet are exhausted.

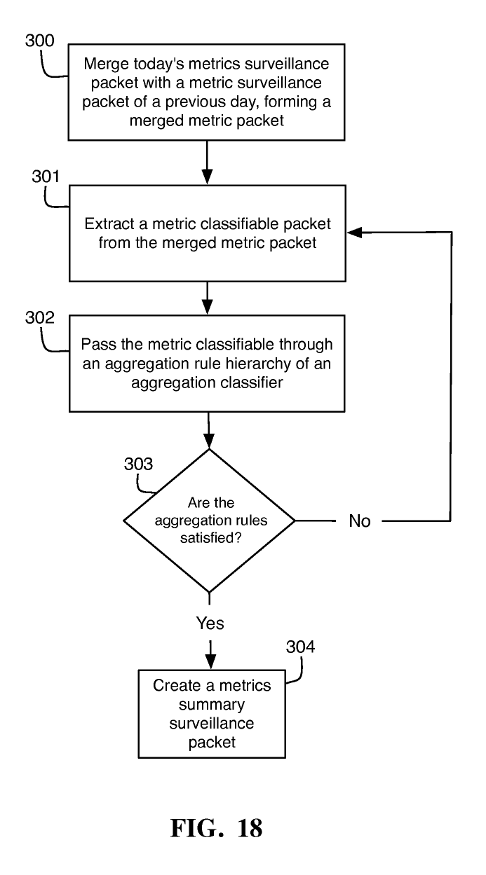

FIG. 18 illustrates the preferred sequence of steps for generating the metric summary surveillance packet. In step 300, FDSM 11 preferably merges the metrics surveillance packet with a previous day's metrics summary surveillance packet forming a merged metrics surveillance packet. Next, FDSM 11 preferably extracts a metric classifiable from the merged metrics surveillance packet in step 301. In step 302, FDSM 11 preferably passes the metric classifiable through an aggregation rule hierarchy attached to an aggregation classifier. In step 303, FDSM 11 preferably determines whether the rules attached to the aggregation classifier are satisfied. If so, FDSM 11 preferably invokes the event handler 87 to generate a metric summary surveillance packet in step 304. Otherwise, FDSM 11 preferably reads the next classifiable in the metric summary surveillance packet by looping back to step 301. This loop will preferably continue until the transactions in the metrics packet are exhausted. It is understood that the classifiable packet may be required to satisfy rules attached to higher-level classifier nodes before being forwarded to the aggregation classifier.

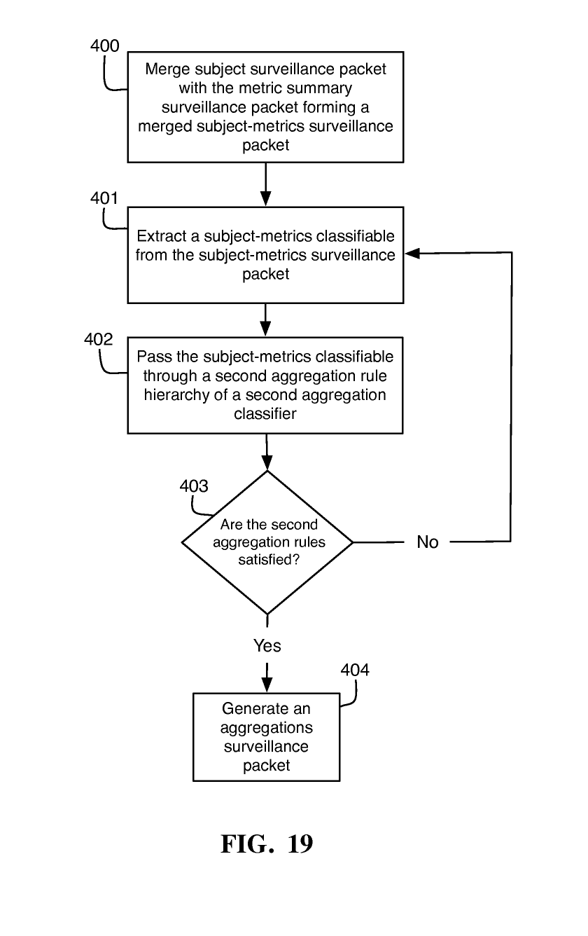

FIG. 19 illustrates a preferred sequence of steps for generating the aggregations surveillance packet. First, FDSM 11 preferably merges the subject surveillance packet with the metric summary surveillance packet forming a merged subject-metrics surveillance packet in step 400. In step 401, FDSM 11 preferably extracts a subject-metrics classifiable from the subject-metrics surveillance packet. Then, FDSM 11 preferably passes the subject-metrics classifiable through a second aggregation rule hierarchy attached to a second aggregation classifier in step 402. In step 403, FDSM 11 preferably determines whether the rules attached to the aggregation classifier are satisfied. If so, FDSM 11 preferably invokes the event handler 87 to generate an aggregations surveillance packet in step 404. Otherwise, FDSM 11 preferably reads the next classifiable in the metrics summary surveillance packet by looping back to step 401. This loop will preferably continue until the classifiables in the metrics summary surveillance packet are exhausted. It is understood that the classifiable packet may be required to satisfy rules attached to higher-level classifier nodes before being forwarded to the second aggregations classifier.

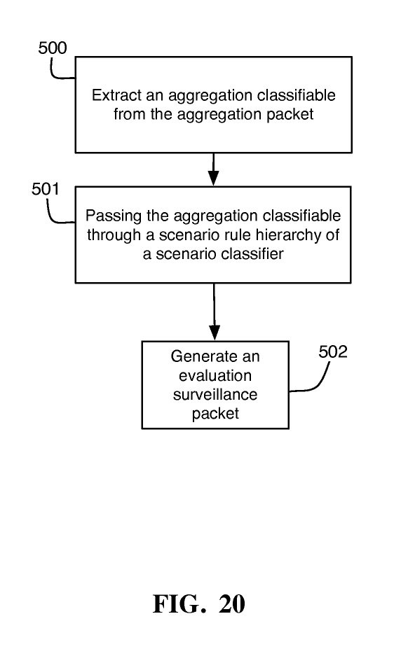

FIG. 20 illustrates a preferred sequence of steps for generating the evaluation surveillance packet. First, FDSM 11 preferably extracts an aggregation classifiable from the aggregation surveillance packet in step 500. In step 501, FDSM 11 preferably passes the aggregation classifiable through a scenario rule hierarchy of a scenario classifier. The rules attached to the scenario classifier are preferably rules that are indicative of suspicious activity. FDSM 11 preferably invokes the event handler 87 to generate an evaluation surveillance packet in step 502 based on the evaluation of the aggregation classifiable within the scenario rule hierarchy. It is understood that the classifiable packet may be required to satisfy rules attached to higher-level classifier nodes before being forwarded to the second scenario classifier.

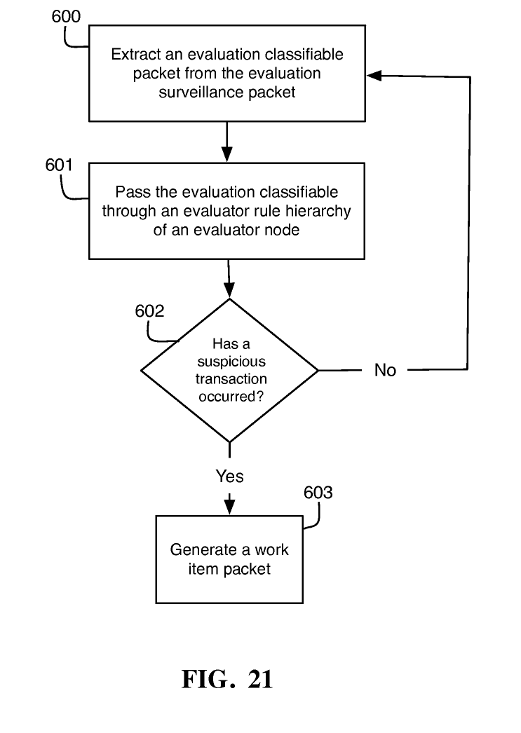

FIG. 21 illustrates a preferred sequence of steps for generating the work item packet. In step 600, FDSM 11 preferably extracts an evaluation classifiable from the evaluation surveillance packet. In step 601, FDSM 11 preferably passes the evaluation classifiable through an evaluator rule hierarchy of an evaluation classifier. In step 602, FDSM 11 preferably determines whether the evaluation score encapsulated in the evaluation surveillance classifiable packet indicates that a suspicious transaction has occurred. If the evaluation score encapsulated in the evaluation surveillance packet indicates that a suspicious transaction occurred, FDSM 11 preferably invokes the event handler 87 and creates a work item packet in step 603. Otherwise, FDSM 11 preferably reads the next classifiable in the evaluation surveillance packet by looping back to step 600. This loop will preferably continue until all the classifiables are exhausted. It is understood that the classifiable packet may be required to satisfy rules attached to higher-level classifier nodes before being forwarded to the work item generation node.

The flowchart and block diagrams in the figures illustrate the architecture, functionality, and operation of possible implementations of systems, methods and computer program products according to various embodiments of the present application. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described and illustrated the principles of this application by reference to one or more preferred embodiments, it should be apparent that the preferred embodiment(s) may be modified in arraignments and detail without departing from the principles disclosed herein and that it is intended that this application be construed as including all such modifications and variations insofar as they come within the spirit and scope of the subject matter disclosed herein.

What is claimed is:

1. A computer-implemented method for surveillance of financial data, comprising:
initiating a financial data surveillance module executable on a processor of a financial data surveillance computer system;
retrieving source data from one or more data sources of a remote data server on which the source data is stored, the source data including transactions for a specific date and identification of the entity and account that each transaction is associated with;
storing the source data in memory of the financial data surveillance computer system;
generating a metrics summary packet for a particular account and the specific date, the metrics summary packet including one or more transaction classifiables that satisfy a predefined set of metric definition rules;
generating a subjects packet for the particular account that identifies the entities associated with the particular account;
generating a subjects-metrics packet for the particular account by combining subject classifiables and transaction classifiables within the subjects packet and metric summary packet;
generating an aggregation packet for an entity associated with the particular account, the aggregation packet including subject and transaction classifiables of the subjects-metrics packet that satisfy a predefined set of aggregation rules;
generating an evaluation score for the entity by passing classifiables of the aggregation packet through a rules engine including a predefined set of scenario rules to determine if the aggregation classifiables are indicative of suspicious financial activity; and
generating a work item if the evaluation score is indicative of suspicious financial activity.

2. The method according to claim 1, further comprising:
generating a transaction surveillance packet for a particular account that includes transactions for a specific date;
generating a metrics surveillance packet for the particular account and the specific date, the metrics surveillance packet including one or more transaction classifiables of the transaction surveillance packet that satisfy a predefined set of metric definition rules; and
generating the metrics summary packet for the particular account by combining transaction classifiables from the metrics surveillance packet with transaction classifiables from previously generated metrics surveillance packets for the particular account for a predetermined time period preceding the specific date.

3. The method according to claim 1, further comprising:
generating an evaluation packet for the entity that includes the evaluation score; and
generating a work item packet for the entity if the evaluation score in the evaluation packet is indicative of suspicious financial activity.

4. The method according to claim 2, wherein generating the metrics surveillance packet comprises:
extracting a transaction classifiable from the transaction surveillance packet; and
passing the transaction classifiable through the predefined set of metric definition rules; and
determining whether the transaction classifiable satisfies the predefined set of metric definition rules.

5. The method according to claim 4, wherein the predefined set of metric definition rules comprise a metric business rule hierarchy attached to a metric classifier of a metadata tree.

6. The method according to claim 2, wherein generating the metric summary packet comprises:
retrieving previously generated metrics surveillance packets from memory;
extracting metric classifiables from the retrieved metrics surveillance packet;
passing the metric classifiables through an aggregation rule hierarchy of an aggregation classifier of the metadata tree;
determining if the metric classifiable satisfies the aggregation rule hierarchy; and
including the metric classifiable in the metric summary packet if it is determined that the metric classifiable satisfies the aggregation rule hierarchy.

7. The method according to claim 1, wherein generating the aggregation packet comprises:
extracting a subject-metrics classifiable from the subject-metrics packet;
passing the subject-metrics classifiable through the predefined set of aggregation rules; and
determining whether the subject-metrics classifiable satisfies the predefined set of aggregation rules.

8. The method according to claim 7, wherein the predefined set of aggregation rules comprise an aggregation rule hierarchy of an aggregation classifier.

9. The method according to claim 3, wherein generating the evaluation packet comprises:
extracting an aggregation classifiable from the aggregation packet;
passing the aggregation classifiable through a scenario rule hierarchy of a scenario classifier; and
generating an evaluation score based on whether the aggregation classifiable satisfies the scenario rule hierarchy of a scenario classifier.

10. The method according to claim 3, further comprising displaying the information contained in the work item surveillance packet.

11. The method according to claim 1, wherein the source data is stored as data objects in memory of the financial data surveillance computer system.

12. The method according to claim 1, further comprising initiating a financial data surveillance job on a surveillance computer system, wherein the financial data surveillance job initiates at least one task pursuant to an execution strategy defined in a configuration file.

13. A system for surveillance of financial data, comprising:
a processor;
a memory comprising program instructions, wherein the program instructions are executable by the processor to:
retrieve source data from one or more data sources of a remote data server on which the source data is stored, the source data including transactions for a specific date and identification of the entity and account that each transaction is associated with;
store the source data in memory of the financial data surveillance computer system;
generate a metrics summary packet for a particular account and the specific date, the metrics summary packet including one or more transaction classifiables that satisfy a predefined set of metric definition rules;
generate a subjects packet for the particular account that identifies the entities associated with the particular account;
generate a subjects-metrics packet for the particular account by combining subject classifiables and transaction classifiables within the subjects packet and metric summary packet;
generate an aggregation packet for a entity associated with the particular account, the aggregation packet including subject and transaction classifiables of the subjects-metrics packet that satisfy a predefined set of aggregation rules;
generate an evaluation score for the entity by passing classifiables of the aggregation packet through a rules engine including a predefined set of scenario rules to determine if the aggregation classifiables are indicative of suspicious financial activity; and
generate a work item if the evaluation score is indicative of suspicious financial activity.

14. The system according to claim 13, wherein the program instructions are further executable by the processor to:
generate a transaction surveillance packet for a particular account that includes transactions for a specific date;
generate a metrics surveillance packet for the particular account and the specific date, the metrics surveillance packet including one or more transaction classifiables of the transaction surveillance packet that satisfy a predefined set of metric definition rules; and
generate the metrics summary packet for the particular account by combining transaction classifiables from the metrics surveillance packet with transaction classifiables from previously generated metrics surveillance packets for the particular account for a predetermined time period preceding the specific date.

15. The system according to claim 13, wherein the program instructions are further executable by the processor to:
generate an evaluation packet for the entity that includes the evaluation score; and
generate a work item packet for the entity if the evaluation score in the evaluation packet is indicative of suspicious financial activity.

16. The system according to claim 14, wherein generating the metrics surveillance packet comprises:
extracting a transaction classifiable from the transaction surveillance packet; and
passing the transaction classifiable through the predefined set of metric definition rules; and
determining whether the transaction classifiable satisfies the predefined set of metric definition rules.

17. The system according to claim 16, wherein the predefined set of metric definition rules comprise a metric business rule hierarchy attached to a metric classifier of a metadata tree.

18. The system according to claim 14, wherein generating the metric summary packet comprises:
retrieving previously generated metrics surveillance packets from memory;
extracting metric classifiables from the retrieved metrics surveillance packet;
passing the metric classifiables through an aggregation rule hierarchy of an aggregation classifier of the metadata tree;
determining if the metric classifiable satisfies the aggregation rule hierarchy; and
including the metric classifiable in the metric summary packet if it is determined that the metric classifiable satisfies the aggregation rule hierarchy.

19. The system according to claim 13, wherein generating the aggregation packet comprises:
extracting a subject-metrics classifiable from the subject-metrics packet;
passing the subject-metrics classifiable through the predefined set of aggregation rules; and
determining whether the subject-metrics classifiable satisfies the predefined set of aggregation rules.

20. The system according to claim 19, wherein the predefined set of aggregation rules comprise an aggregation rule hierarchy of an aggregation classifier.

21. The system according to claim 15, wherein generating the evaluation packet comprises:
extracting an aggregation classifiable from the aggregation packet;
passing the aggregation classifiable through a scenario rule hierarchy of a scenario classifier; and
generating an evaluation score based on whether the aggregation classifiable satisfies the scenario rule hierarchy of a scenario classifier.

22. The system according to claim 15, wherein information contained in the work item surveillance packet is displayed to an end user.

23. The system according to claim 13, wherein the source data is stored as data objects in memory of the financial data surveillance computer system.

24. The system according to claim 13, wherein a financial data surveillance job initiates at least one task pursuant to an execution strategy defined in a configuration file.

25. An article comprising a machine-readable medium that store machine-executable instructions for causing a machine to:
retrieve source data from one or more data sources of a remote data server on which the source data is stored, the source data including transactions for a specific date and identification of the entity and account that each transaction is associated with;
store the source data in memory;
generate a metrics summary packet for a particular account and the specific date, the metrics summary packet including one or more transaction classifiables that satisfy a predefined set of metric definition rules;
generate a subjects packet for the particular account that identifies the entities associated with the particular account;
generate a subjects-metrics packet for the particular account by combining subject classifiables and transaction classifiables within the subjects packet and metric summary packet;
generate an aggregation packet for a entity associated with the particular account, the aggregation packet including subject and metric classifiables of the subjects-metrics packet that satisfy a predefined set of aggregation rules;
generate an evaluation score for the entity by passing classifiables of the aggregation packet through a rules engine including a predefined set of scenario rules to determine if the aggregation classifiables are indicative of suspicious financial activity; and
generate a work item if the evaluation score is indicative of suspicious financial activity.

26. The article according to claim 25, including machine-executable instructions for causing the machine to:
generate a transaction surveillance packet for a particular account that includes transactions for a specific date;
generate a metrics surveillance packet for the particular account and the specific date, the metrics surveillance packet including one or more transaction classifiables of the transaction surveillance packet that satisfy a predefined set of metric definition rules; and
generate the metrics summary packet for the particular account by combining metric classifiables from the metrics surveillance packet with metric classifiables from previously generated metrics surveillance packets for the particular account for a predetermined time period preceding the specific date.

27. The article according to claim 25, including machine-executable instructions for causing the machine to:
generate an evaluation packet for the entity that includes the evaluation score; and
generate a work item packet for the entity if the evaluation score in the evaluation packet is indicative of suspicious financial activity.

28. The article according to claim 26, wherein generating the metrics surveillance packet comprises:
extracting a transaction classifiable from the transaction surveillance packet; and
passing the transaction classifiable through the predefined set of metric definition rules; and
determining whether the transaction classifiable satisfies the predefined set of metric definition rules.

29. The article according to claim 28, wherein the predefined set of metric definition rules comprise a metric business rule hierarchy attached to a metric classifier of a metadata tree.

30. The article according to claim 26, wherein generating the metric summary packet comprises:
retrieving previously generated metrics surveillance packets from memory;
extracting metric classifiables from the retrieved metrics surveillance packet;
passing the metric classifiables through an aggregation rule hierarchy of an aggregation classifier of the metadata tree;
determining if the metric classifiable satisfies the aggregation rule hierarchy; and
including the metric classifiable in the metric summary packet if it is determined that the metric classifiable satisfies the aggregation rule hierarchy.

31. The article according to claim 25, wherein generating the aggregation packet comprises:
extracting a subject-metrics classifiable from the subject-metrics packet;
passing the subject-metrics classifiable through the predefined set of aggregation rules; and
determining whether the subject-metrics classifiable satisfies the predefined set of aggregation rules.

32. The article according to claim 31, wherein the predefined set of aggregation rules comprise an aggregation rule hierarchy of an aggregation classifier.

33. The article according to claim 27, wherein generating the evaluation packet comprises:
extracting an aggregation classifiable from the aggregation packet;
passing the aggregation classifiable through a scenario rule hierarchy of a scenario classifier; and
generating an evaluation score based on whether the aggregation classifiable satisfies the scenario rule hierarchy of a scenario classifier.

34. The article according to claim 27, wherein information contained in the work item surveillance packet is displayed to an end user.

35. The article according to claim 25, wherein the source data is stored as data objects in memory of the financial data surveillance computer system.

36. The article according to claim 25, wherein a financial data surveillance job initiates at least one task pursuant to an execution strategy defined in a configuration file.
